(19) United States
(12) Patent Application Publication
(10) Pub. No.: US 2014/0333547 A1
(43) Pub. Date: Nov. 13, 2014

(54) TOUCH PANEL

(71) Applicant: Quanta Computer Inc., TAOYUAN SHIEN (TW)

(72) Inventors: Chien-Yu Yi, Zhongli City (TW); Kuo-Liang Shen, Taipei City (TW); Ching-Feng Chen, New Taipei City (TW)

(73) Assignee: Quanta Computer Inc., TAOYUAN SHIEN (TW)

(21) Appl. No.: 14/097,153

(22) Filed: Dec. 4, 2013

(30) Foreign Application Priority Data
May 8, 2013 (TW) 102116367

(51) Int. Cl. G06F 3/041

(52) U.S. Cl. CPC G06F 3/041
USPC 345/173

(57) ABSTRACT

A touch panel includes a substrate, a first sensing series, a second sensing series, a transmitting IC, a receiving IC, a plurality of first control-signal lines, a plurality of second control-signal lines, a flexible circuit board and a control unit. The transmitting IC is configured to transmit a signal to the first sensing series. The receiving IC is configured to receive a signal from the second sensing series. The flexible circuit board has a junction end bonded on a bonding area of the substrate, and is connected to the first and second control-signal lines. The control unit transmits a first control signal and a second control signal respectively to the transmitting IC and the receiving IC through the flexible circuit board.

### CROSS-REFERENCE TO RELATED APPLICATIONS

This application claims priority to Taiwan application No. 102116367, filed May 8, 2013, the entirety of which is incorporated herein by reference.

### FIELD OF THE INVENTION

The present invention relates to a touch panel.

### BACKGROUND

There has been a trend of user-oriented design in electronic products, and electronic devices using touch panels as input interface become a major stream in the market due to the convenience in operation. For example, the touch panels are important and necessary parts of smart phones and tablet PCs. Currently, touch panels are roughly classified into resistive touch panels, capacitive touch panels, optic touch panels and electromagnetic touch panels. In light of technical maturity and universality of the market, capacitive touch panels are the most widely used among these techniques. Furthermore, the size of the touch panel is required to be increased. When the size of the touch panel increases, some driving approaches used in small size touch panel can not be effectively unitized. Therefore, there exists a need of an improved driving approach suitable for large size touch panel.

### SUMMARY

According to one aspect of the present disclosure, a touch panel is provided. The touch panel includes a substrate, a plurality of first sensing series, a plurality of second sensing series, a first semiconductor chip and a plurality of control-signal lines. The substrate has a sensing region and a peripheral region surrounding the sensing region. The first sensing series is disposed on the sensing region. Each of the second sensing series intersects each of the first sensing series. The first semiconductor chip is disposed on the peripheral region of the substrate. The first semiconductor chip includes a transmitting unit, a receiving unit and a control unit. The transmitting unit is configured to transmit signals to the first sensing series. The receiving unit is configured to receive signals from the second sensing series. The control unit is configured to control the transmitting unit and the receiving unit. The control-signal lines are formed on the peripheral region of the substrate, and the control-signal lines extend from a side edge of the substrate to a position under the first semiconductor chip so as to transmit control signals to the control unit.

According to another aspect of the present disclosure, a touch panel is provided. The touch panel includes a substrate, a plurality of first sensing series, a plurality of second sensing series, at least one transmitting chip, at least one receiving chip, a plurality of first control-signal lines, a plurality of second control-signal lines, a flexible circuit board, ad a control unit. The substrate has a sensing region and a peripheral region surrounding the sensing region. The first sensing series are disposed on the sensing region. Each second sensing series intersects at least one of the first sensing series. The transmitting chip is disposed on the peripheral region of the substrate and configured to output signals to the first sensing series. The receiving chip is disposed on the peripheral region of the substrate and configured to receive signals from the second sensing series. The first control-signal lines are provided for transmitting first control-signals to the transmitting chip. The second control-signal lines are provided for transmitting second control-signals to the receiving chip, in which each of the first and second control-signal lines has an end converged on a bonding area of the substrate. The flexible circuit board has a junction end bonded on the bonding area and connected with the first control-signal lines and second control-signal lines. The control unit is configured to output the first control-signals and the second control-signals respectively to the transmitting chip and the receiving chip through the flexible circuit board.

### BRIEF DESCRIPTION OF THE DRAWINGS

FIGS. 1-7 are top views schematically illustrating touch panels according to various embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

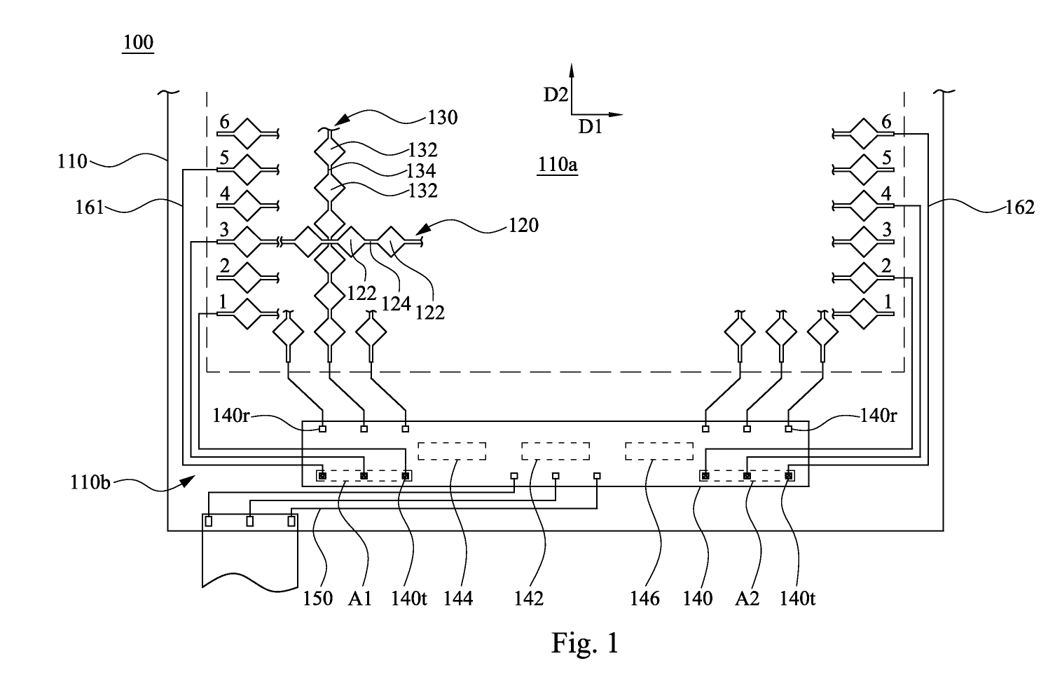

FIG. 1 is a top view schematically illustrating a touch panel 100 according to one embodiment of the present disclosure. The touch panel 100 includes a substrate 110, a plurality of first sensing series 120, a plurality of second sensing series 130, a first driving chip 140 and a plurality of control-signal lines 150.

The substrate 110 has a sensing region 110a and a peripheral region 110b. The peripheral region 110b is positioned at the periphery of the substrate 110, and the peripheral region 110b surrounds the sensing region 110a. The substrate 110 may be, for example, a glass substrate, a polyethylene terephthalate (PET) substrate or any suitable substrate. In some embodiments, the substrate 110 is a transparent substrate, but the present disclosure is not limited thereto.

The plurality of the first sensing series 120 are disposed on the sensing region 110a of the substrate 110. In specifics, each of the first sensing series 120 includes a plurality of first sensing pads 122 and a plurality of first bridges 124, and each of the first bridges 124 interconnects two adjacent ones of the first sensing pads 122. In some embodiments, each of the first sensing series 120 extends substantially in a first direction D1.

Each of the second sensing series 130 intersects at least one of the first sensing series 120. In some embodiments, each of the second sensing series 130 intersects numerous first sensing series 120. Each of the second sensing series 130 includes a plurality of second sensing pads 132 and a plurality of second bridges 134, and each of the second bridges 134 interconnects two adjacent ones of the second sensing pads 132. Each second sensing series 130 extends in a second direction D2, which is different from the first direction D1. For example, the second direction D2 is substantially perpendicular to the first direction D1. In some embodiments, the second direction D2 may be not perpendicular to the first direction D1. With reference to FIG. 1, the second sensing series 130 and the first sensing series 120 are formed on the sensing region 110a of the substrate 110. Nevertheless, the second sensing series 130 are not in contact with the first sensing series 120. For instance, a dielectric layer (not shown in FIG. 1) may be formed between the second sensing series 130 and the first sensing series 120. The dielectric layer may cover the entire sensing region 110a of the substrate 110. Otherwise, the dielectric layer may be disposed merely at the intersections of the second sensing series 130 and the first sensing series 120. In yet some embodiments, the second sensing series 130 is formed on another substrate (not shown in FIG. 1), and a dielectric layer is disposed between the two substrates so as to space the second sensing series 130 apart from the first sensing series 120.

The first driving chip 140 is disposed on the peripheral region 110b of the substrate 110. In some embodiments, the first driving chip 140 is bonded on the substrate 110 by chip-on-glass techniques. The first driving chip 140 includes a control unit (MCU) 142, a transmitting unit (TX) 144 and a receiving unit (RX) 146. The transmitting unit 144 is configured to transmit detecting signals to the first sensing series 120, and the receiving unit 146 is configured to receive signals from the second sensing series 130. The control unit 142 is configured to control and harmonize the transmitting unit 144 and the receiving unit 146.

The control-signal lines 150 are formed on the peripheral region 110b of the substrate 110, and are provided for transmitting one or more sets of control signals to the control unit 142 of the first driving chip 140. The control-signal lines 150 is extended from an edge of the substrate 110 to a position under the first driving chip 140, and is further connected to the first driving chip 140. In some embodiments, the control signals transmitted on the control-signal lines 150 are in I2C mode, SPI mode or USB mode. Accordingly, the number of the control-signal lines 150 is about 4 to about 12 so that the total number of the control-signal lines 150 is reduced according to some embodiments of the present disclosure.

In some embodiments, the touch panel 100 further includes a flexible circuit board 154, which is bonded on the edge of the substrate 110 and electrically connected to the control-signal lines 150. When the number of the control-signal lines 150 decreases, the number of the conductor lines required in the flexible circuit board 154 is decreased as well.

The first driving chip 140 further includes a plurality of output terminals 140t and a plurality of reception terminals 140r. The output terminals 140t and the reception terminals 140r may be contact pads, for example. The output terminals 140t and the reception terminals 140r are respectively connected to the transmitting unit 144 and the receiving unit 146. Furthermore, each of the output terminals 140t is electrically connected to at least one of the first sensing series 120 whereas each of the reception terminals 140r is electrically connected to at least one of the second sensing series 130. In examples, the number of the reception terminals 140r is greater than that of the output terminals 140t.

In some embodiments, the touch panel 100 further includes a plurality of first signal lines 161 for transmitting the signal from the output terminals 140t to the first sensing series 120. In specifics, the first signal lines 161 are positioned on the peripheral region 110b, and each of the first signal lines 161 is electrically interconnects one of the output terminal 140t and a corresponding one of the first sensing series 120.

In yet some embodiments, the touch panel 100 further includes a plurality of second signal lines 162 disposed on the peripheral region 110b. The second signal lines 162 and the first signal lines 161 are respectively positioned at opposites sides of the substrate 110. Specifically, the output terminals 140t are classified into a first group A1 and a second group A2. The output terminals 140t belonging to the first group A1 are connected to some of the first sensing series 120 through the first signal line 161, whereas the output terminals 140t belonging to the second group A2 are connected to the others of the first sensing series 120 through the second signal lines 162. For examples, the output terminals 140t belonging to the first group A1 are connected to odd numbers of the first sensing series 120 (for example, numerals 1, 3, 5 shown in FIG. 1) through the first signal line 161. The output terminals 140t belonging to the second group A2 are connected to even numbers of the first sensing series 120 (for example, numerals 2, 4, 6 shown in FIG. 1) through the second signal lines 162. In other embodiments, the output terminals 140t of the first group A1 are connected to the first sensing series 120 located in the top half of the sensing region 110a (not shown in FIG. 1) through the first signal lines 161. Furthermore, the output terminals 140t of the second group A2 are connected to the first sensing series 120 located in the bottom half of the sensing region 110a through the second signal lines 162. The number of the output terminals 140t belonging to the first group A1 may be the same as or different from that belonging to the second group A2.

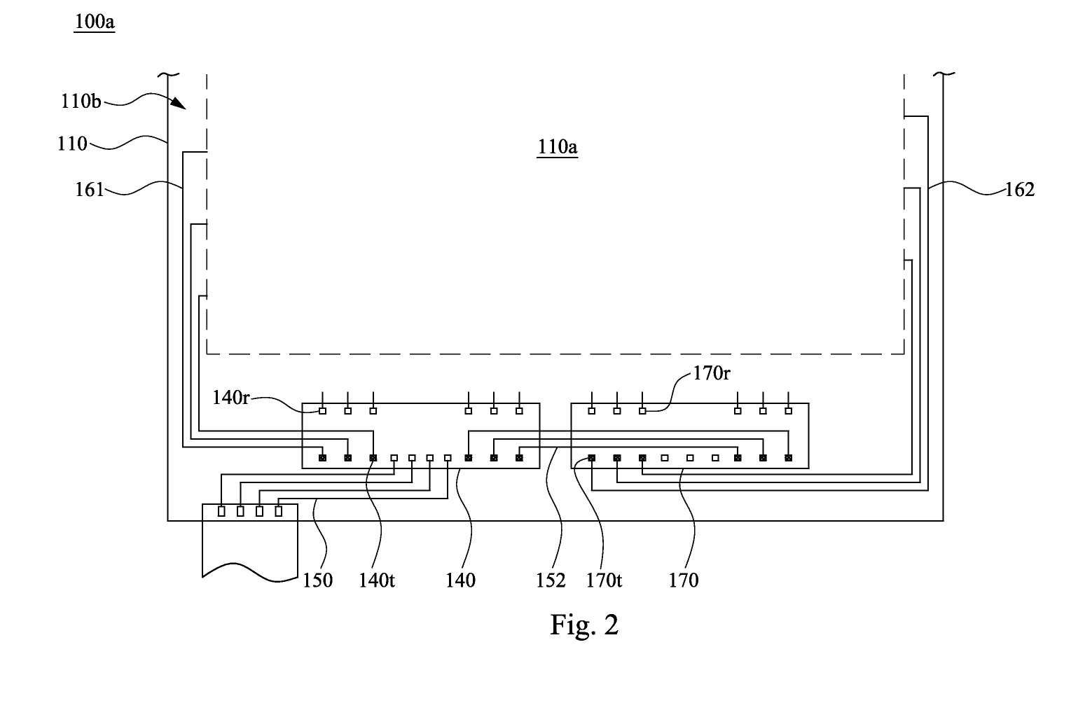

The touch panel may include a number of driving chips according to various embodiments of the present disclosure, as shown in FIG. 2. The touch panel 100a further includes a second driving chip 170 which is disposed on the peripheral region 110b of the substrate 110. The second driving chip 170 is controlled by the first driving chip 140. In other words, the first driving chip 140 and the second driving chip 170 have a master-slave relationship, in which the first driving chip 140 is a master chip or master IC whereas the second driving chip 170 is a slave chip or slave IC. It is noted that the second driving chip 170 is the same as the first driving chip 140 in structure. As described hereinbefore, the first driving chip 140 includes a control unit, a transmitting unit and a receiving unit. Identically, the second driving chip 170 has a control unit, a transmitting unit and a receiving unit, but the control unit of the second driving chip 170 is substantially idle and unused. In operation, the first driving chip 140 controls the second driving chip 170. Furthermore, the touch panel 100a further includes a plurality of second control-signal lines 152 disposed on the peripheral region 110b. The second control-signal lines 152 electrically interconnect the first driving chip 140 and the second driving chip 170 in order to transmit one or more control signals to the second driving chip 170. Therefore, a single specification of driving chips is required in the touch panel 100a, which results in a decrease in manufacturing cost according to the embodiments of the present disclosure.

Referring back to FIG. 2, the touch panel 100a further includes a plurality of first signal lines 161 and a plurality of second signal lines 162. All of the first and second signal lines 161,162 are disposed on the peripheral region 110b of the substrate 110. In one example, the first driving chip 140 transmits signals to some of the first sensing series 120 (shown in FIG. 1) through the first signal lines 161 whereas the second driving chip 170 transmits signals to the others of the first sensing series 120 through the second signal lines 162. In another example, each of the first sensing series 120 corresponds to one of the first signal lines 161 and one of the second signal lines 162 for implementing dual-side driving. More specifically, the opposite sides of each first sensing series 120 are respectively connected to the corresponding one of the first signal lines 161 and the corresponding one of second signal lines 162 (not shown in FIG. 2).

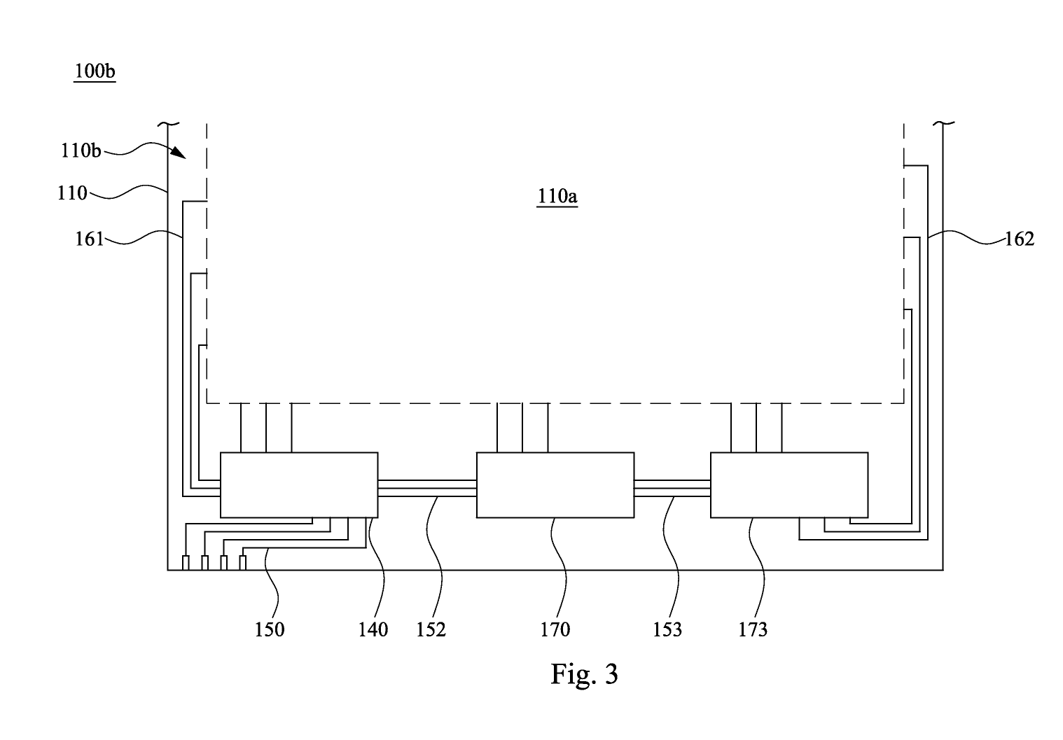

Similarly, the touch panel may include three or more driving chips, as shown in FIG. 3. The touch panel 100b further includes a third driving chip 173 and a plurality of third control-signal lines 153. The second control-signal lines 152 electrically interconnect the first driving chip 140 and the second driving chip 170. The third control-signal lines 153 electrically interconnect the second driving chip 170 and the third driving chip 173. The third driving chip 173 transmits signals to the first sensing series 120 through the second signal line 162.

While the size of the touch panel increases, both the driving voltage and driving capability of the transmitting unit 144 (shown in FIG. 1) have to be increased. Accordingly, high-voltage semiconductor processes are necessary to manufacture the integrated circuit of the transmitting unit 144. In addition, while the resolution of the touch panel increases, the requirements of both the calculation capability and the memory space of the control unit 142 are increased considerably. Accordingly, there exists a need for an improved driving structure suitable for touch panels with high resolution and large size, which is described in detail hereinafter.

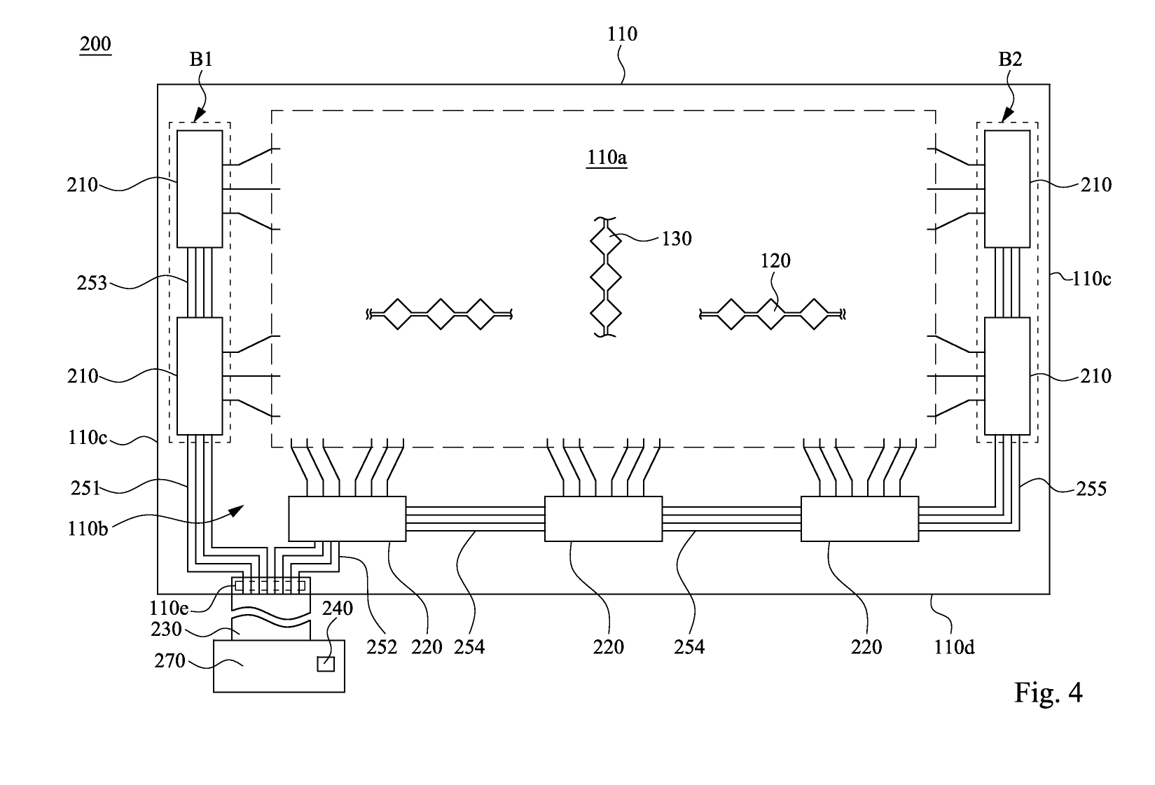

FIG. 4 is a top view schematically illustrating a touch panel 200 according to one embodiment of the present disclosure. The touch panel 200 includes at least one transmitting chip 210, at least one receiving chip 220, a flexible circuit board 230, a control unit 240, a plurality of first control-signal lines 251 and a plurality of second control-signal lines 252. In addition, the touch panel 200 further includes a substrate 110, a plurality of first sensing series 120, and a plurality of second sensing series 130. The substrate 110, the first sensing series 120 and the second sensing series 130 may be the same as these described hereinbefore in connection with FIG. 1, and therefore the description thereof is omitted to avoid repetition.

The transmitting chip 210 is disposed on the peripheral region 110b of the substrate 110. The transmitting chip 210 is configured to transmit detecting signals to the first sensing series 120. The transmitting chip 210 is different in structure from the first driving chip 140 described hereinbefore. In one example, the transmitting chip 210 does not include any control unit (MCU) and any receiving unit (RX), and the transmitting chip 210 is controlled by the control unit 240 disposed out of the substrate 110.

The receiving chip 220 is disposed on the peripheral region 110b of the substrate 110, and is configured to receive the signals transmitted from the second sensing series 130. The receiving chip 220 is different in structure from the first driving chip 140 described hereinbefore. In one example, the receiving chip 220 does not include any control unit (MCU) and any transmitting unit (TX). The receiving chip 220 is controlled by the control unit 240 disposed out of the substrate 110.

The first control-signal lines 251 are provided for transmitting one or more control signals to the transmitting chip 210. In specifics, the control unit 240 transmits control signals to the transmitting chip 210 through the first control-signal lines 251. In some embodiments, the first control-signal lines 251 are disposed on the peripheral region 110b of the substrate 110, and the first control-signal lines 251 extend from the bonding area 110e of the substrate 110 to a position under the transmitting chip 210, and thereby electrically connecting to the transmitting chip 210.

The second control-signal lines 252 are provided for transmitting one or more control signals to the receiving chip 220. Specifically, the control unit 240 transmits control signals to the receiving chip 220 through the second control-signal lines 252. In some embodiments, the second control-signal lines 252 are disposed on the peripheral region 110b of the substrate 110. The second control-signal lines 252 extend from the bonding area 110e of the substrate 110 to a position under the receiving chip 220, and thereby electrically connecting to the receiving chip 220.

The control unit 240 transmits control signals to both of the transmitting chip 210 and the receiving chip 220 through the flexible circuit board 230. The control unit 240 may be disposed on an external circuit board 270. Furthermore, one end of the flexible circuit board 230 is bonded on the external circuit board 270, whereas another end of the flexible circuit board 230 is bonded on the bonding area 110e of the substrate 110. Therefore, the flexible circuit board 230 is electrically connected to the first control-signal lines 251 and the second control-signal lines 252. The control unit 240 transmits first control-signals to the transmitting chip 210 through the flexible circuit board 230 and the first control-signal lines 251, and transmits second control-signals to the receiving chip 220 through the flexible circuit board 230 and the second control-signal lines 252. The first control-signals and the second control-signals are in SPI mode or I2C mode, for example.

In some embodiments, the touch panel 200 includes a plurality of transmitting chips 210 and a plurality of receiving chips 220, as shown in FIG. 4. The transmitting chips 210 are arranged along the short side 110c of the substrate 110, whereas the receiving chips 220 are arranged along the long side 110d of the substrate 110. In this embodiment, the touch panel 200 further includes a plurality of third control-signal lines 253 and a plurality of fourth control-signal lines 254. The third control-signal lines 253 and the fourth control-signal lines 254 are disposed on the peripheral region 110b of the substrate 110. Each of the third control-signal lines 253 interconnects two adjacent ones of the transmitting chips 210. In addition, each of the fourth control-signal lines interconnects two adjacent ones of the receiving chips 220.

In another embodiment, the transmitting chips 210 are classified into a first group B1 and a second group B2, as shown in FIG. 4. The first group B1 and the second group B2 of the transmitting chips 210 are respectively disposed at opposite sides of the substrate 110. The control unit 240 controls the first group B1 of the transmitting chips 210 through the first control-signal lines 251. Furthermore, the control unit 240 controls the second group B2 of the transmitting chips 210 through the second control-signal lines 252. Specifically, the touch panel 200 may includes a plurality of fifth control-signal lines 255 disposed on the peripheral region 110b, in which the fifth control-signal lines 255 interconnect one of the receiving chips 220 and one of the transmitting chips 210 belonging to the second group B2. Accordingly, the control unit 240 may control the second group B2 of the transmitting chips 210 through the second control-signal lines 252, the receiving chip 220, the fourth control-signal lines 254 and the fifth control-signal lines 255. In one example, the first group B1 of the transmitting chips 210 transmit signals to some of the first sensing series 120, and the second group B2 of the transmitting chips 210 transmit signals to others of the first sensing series 120. For examples, the first group B1 of the transmitting chips 210 transmit signals to odd numbers of the first sensing series 120, and the second group B2 of transmitting chips 210 transmit signals to even numbers of the first sensing series 120. In another example, the first group B1 of transmitting chips 210 corresponds to the second group B2 of the transmitting chips 210 for implementing dual-side driving. In structures of dual-side driving, opposite sides of each first sensing series 120 are respectively coupled to one of the transmitting chips 210 of the first group B1 and one of the transmitting chips 210 of the second group B2.

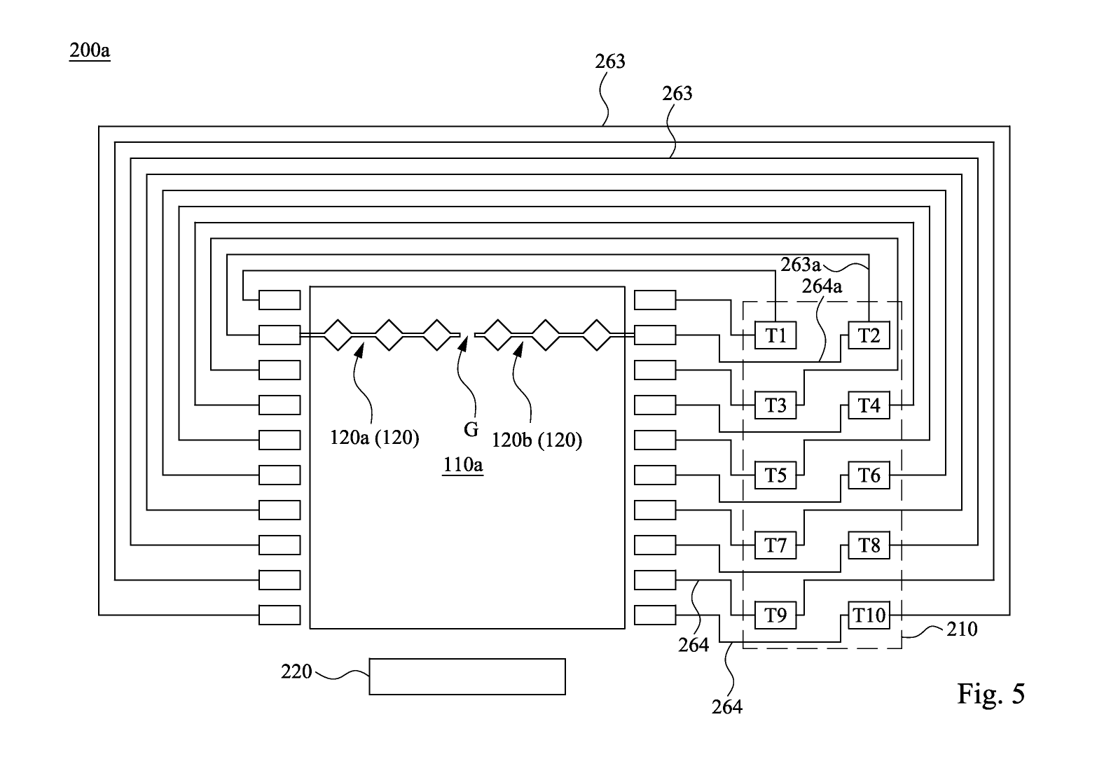

FIG. 5 is a top view schematically illustrating a touch panel 200a according to still another embodiment of the present disclosure. In the present embodiment, dual-side driving is realized while the transmitting chip(s) 210 is disposed at a single side of the sensing region 110a. The touch panel 200a further includes a plurality of third signal lines 263 and a plurality of fourth signal lines 264. Each of the third signal line 263 corresponds to one of the fourth signal lines 264. More specifically, as shown in FIG. 5, the third signal line 263a corresponds to the fourth signal line 264a, and both the third signal line 263a and fourth signal line 264a are connected to the same output terminal T2 of the transmitting chip 210. The third signal line 263a extends from a side of the sensing region 110a, detouring around the sensing region 110a, to an opposite side of the sensing region 110a. In addition, each of the first sensing series 120 is comprised of a first portion 120a and a second portion 120b. The first portion 120a is spaced apart from the second portion 120b by a gap G. The third signal line 263a has an end positioned under the transmitting chip 210 so as to electrically connect to the output terminal T2 of the transmitting chip 210. Furthermore, another end of the third signal line 263a is coupled to the first portion 120a of the first sensing series 120. In addition, an end of the fourth signal line 264a is coupled to the second portion 120b of the first sensing series 120, whereas another end of fourth signal line 264a extends to a position under the transmitting chip 210 so as to electrically connect to the output terminal T2. Consequently, dual-side driving is realized in a manner that the transmitting chip(s) 210 is arranged at a single side of the sensing region 110a, and the number of the transmitting chips is reduced.

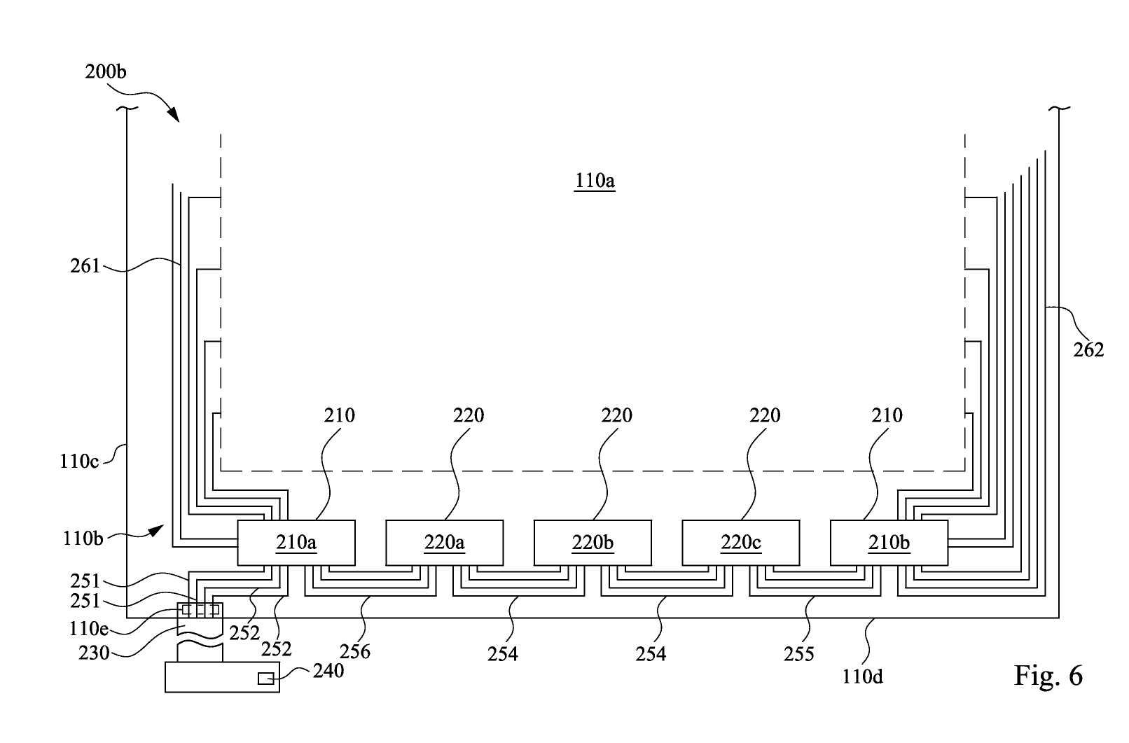

FIG. 6 is a top view schematically illustrating a touch panel 200b according to still another embodiment of the present disclosure. The major difference between this embodiment and the touch panel 200 shown in FIG. 4 is that all of the transmitting chips 210 and the receiving chips 220 are arranged along the long side 110d of the substrate 110. In specifics, the first control-signal lines 251 and the second control-signal lines 252 extend from the bonding area 110e of the substrate 110 to a position under the transmitting chip 210a. The control unit 240 transmits control signals to the transmitting chip 210a through the first control-signal lines 251 and the second control-signal lines 252. A number of sixth control-signal lines 256 are disposed to interconnect the transmitting chip 210a and the receiving chip 220a, and serves as a path of signal transmission between the control unit 240 and each of the receiving chip 220a, 220b, 220c and the transmitting chip 210b. Moreover, the first signal lines 261 and the second signal lines 262 are disposed on opposite sides of the substrate 110. Each first signal line 261 electrically interconnects the transmitting chip 210a and one of the first sensing series in the sensing region 110a. Each second signal line 262 electrically interconnects the transmitting chip 210b and one of the first sensing series the sensing region 110a. Other elements, details and features of this embodiment may be the same as these described hereinbefore in connection with FIG. 4.

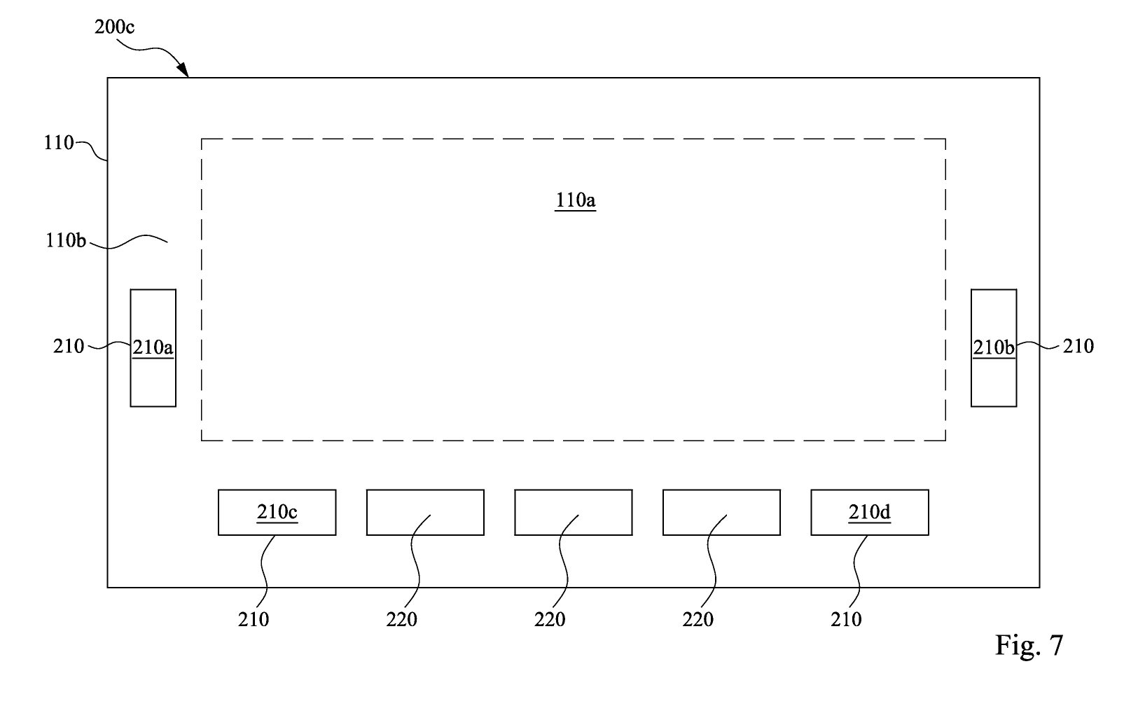

FIG. 7 is a top view schematically illustrating a touch panel 200c according to still another embodiment of the present disclosure. The different between the touch panel 200c and the touch panel 200b shown in FIG. 6 is that some of the transmitting chips 210 are disposed on the peripheral region 110b at positions adjacent to the short side of substrate, whereas others of the transmitting chip 210 are disposed on the peripheral region 110b at positions adjacent to the long side of the substrate. For example, as shown in FIG. 7, the transmitting chips 210a, 210b are positioned adjacent to the short side of the substrate 110, whereas the transmitting chip 210c, 210d are positioned adjacent to the long side of substrate 110.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A touch panel, comprising:
a substrate having a sensing region and a peripheral region surrounding the sensing region;
a plurality of first sensing series disposed on the sensing region;
a plurality of second sensing series, each second sensing series intersecting at least one of the first sensing series;
at least one transmitting chip disposed on the peripheral region of the substrate and configured to output signals to the first sensing series;
at least one receiving chip disposed on the peripheral region of the substrate and configured to receive signals from the second sensing series;
a plurality of first control-signal lines for transmitting a first control-signal to the transmitting chip;
a plurality of second control-signal lines for transmitting a second control-signal to the receiving chip, wherein each of the first and second control-signal lines has an end converged on a bonding area of the substrate;
a flexible circuit board having a junction end bonded on the bonding area and connected with the first control-signal lines and second control-signal lines; and
a control unit configured to output the first control-signal and the second control-signal respectively to the transmitting chip and the receiving chip through the flexible circuit board.

2. The touch panel according to claim 1, wherein the at least one transmitting chip comprises a plurality of transmitting chips, and the substrate has a long side and a short side, wherein the transmitting chips are arranged along the short side.

3. The touch panel according to claim 2, further comprising a plurality of third control-signal lines deposed on the peripheral region of the substrate, wherein the third control-signal lines interconnects two adjacent ones of the transmitting chips.

4. The touch panel according to claim 1, wherein the at least one transmitting chip comprises a plurality of transmitting chips, and the transmitting chips are classified into a first group and a second group respectively disposed on opposite sides of the sensing region.

5. The touch panel according to claim 4, wherein the control unit controls the first group of the transmitting chips and the second group of the transmitting chips respectively through the first control-signal lines and the second control-signal lines.

6. The touch panel according to claim 1, wherein the at least one receiving chip comprises a plurality of receiving chips, and the substrate has a long side and a short side, wherein the receiving chips arranged along the long side.

7. The touch panel according to claim 6, further comprising a plurality of fourth control-signal lines disposed on the peripheral region of the substrate, wherein the fourth control-signal lines interconnects two adjacent ones of the receiving chips.

8. The touch panel according to claim 6, further comprising a plurality of fifth control-signal lines disposed on the peripheral region of the substrate, and wherein the at least one receiving chip comprises a plurality of receiving chips, the fifth control-signal lines interconnect one of the transmitting chips and one of the receiving chips.

9. The touch panel according to claim 1, wherein the first control-signal lines extend from a position under the transmitting chip to the bonding area of the substrate.

10. The touch panel according to claim 1, wherein the second control-signal lines extends from a position under the receiving chip to the bonding area of the substrate.

11. The touch panel according to claim 1, wherein the at least one transmitting chip comprises a plurality of transmitting chips, the at least one receiving chip comprises a plurality of receiving chips, and the substrate has a long side and a short side, wherein the transmitting chips and the receiving chips are arranged along the long side, and each of the first and the second control-signal lines extends from a position under the transmitting chip to the bonding area of the substrate.

12. The touch panel according to claim 1, further comprising a plurality of third signal lines and a plurality of fourth signal lines, the third and fourth signal lines being positioned on the peripheral region, and each of the third signal lines corresponding to one of the fourth signal lines, wherein said corresponding ones of the third and fourth signal lines are connected to opposite sides of an identical one of the first sensing series, and have a respective end coupled to an identical output terminal of the transmitting chip, wherein the third signal lines extend from a side of the sensing region, detouring around the sensing region, to an opposite side of the sensing region.
